(19) United States
(12) Patent Application Publication
(10) Pub. No.: US 2025/0135997 A1
(43) Pub. Date: May 1, 2025

(54) DIGITAL REAR MIRROR FOR PROVIDING INFORMATION RELATED TO LANE CHANGE OF VEHICLE AND OPERATING METHOD OF THE SAME

(71) Applicant: THINKWARE CORPORATION, Seongnam-si (KR)

(72) Inventors: Soon Woo PARK, SEONGNAM-SI (KR); Hyun Chul CHO, SEONGNAM-SI (KR)

(21) Appl. No.: 18/934,072

(22) Filed: Oct. 31, 2024

(30) Foreign Application Priority Data
Nov. 1, 2023 (KR) 10 2023 0149210
Oct. 28, 2024 (KR) 10 2024 0148827

(51) Int. Cl. B60R 1/12; B60R 1/04; G06V 20/58; G06V 20/62

(52) U.S. Cl. CPC B60R 1/12; B60R 1/04; G06V 20/58; G06V 20/625; B60R 2001/1215; B60R 2300/804; B60R 2300/8066; G06V 2201/08

(57) ABSTRACT

The present disclosure provides digital rear mirror device for providing information related to lane change of vehicle and operating method of the same. In the present disclosure, the digital rear mirror device is mounted on the vehicle and configured to obtain a rear image while the vehicle is traveling, recognize at least one other vehicle in an adjacent lane from the rear image, determine whether the other vehicle is within a reference distance from the vehicle using the rear image, and provide information related to lane change to the adjacent lane while displaying the rear image if the other vehicle is within the reference distance.

### CROSS-REFERENCE TO RELATED APPLICATION

This application claims priority to Korean Patent Application Nos. 10-2023-0149210, filed on Nov. 1, 2023, and 10-2024-0148827, filed on Oct. 28, 2024, under 35 U.S.C. § 119, both of which are incorporated herein by reference in their entirety.

### BACKGROUND

### 1. Field

The present disclosure relates to digital rear mirror (DRM) device for providing information related to lane change of vehicle and operating method of the same.

### 2. Description of Related Art

Generally, a driver of a vehicle checks a left or right lane of the vehicle via a side mirror to decide whether to make a lane change of the vehicle. Specifically, the driver decides, according to his driving experience, whether the lane change may proceed by estimating the distance to the other vehicle based on the appearance, e.g., size, of the other vehicle in that lane as seen through the side mirror. At this time, when there is no other vehicle in that lane or the distance from the other vehicle is greater than the reference distance, the driver decides that the lane change may proceed, where the reference distance differs according to the skill level of the driver.

However, the driver's decision of whether to make a lane change based on an individual's subjective determination as described above threatens the safety of the vehicle or the driver. That is, depending on the driver's skill level, the driver may make an incorrect determination. Since the driver may not be able to determine the appropriate reference distance, it is possible to decide whether to make a lane change based on an inappropriate reference distance. Alternatively, even if the distance from the other vehicle is greater than the reference distance, the driver needs to consider the speed of the other vehicle to decide whether to make a lane change, but it may be difficult for the driver to determine the speed only with the appearance of the other vehicle seen through the side mirror.

### SUMMARY

The present disclosure provides digital rear mirror device for providing information related to lane change of vehicle and operating method of the same.

In the present disclosure, a method of operating a digital rear mirror device of a vehicle may include: obtaining a rear image while the vehicle is traveling; recognizing at least one other vehicle in an adjacent lane from the rear image; determining whether the other vehicle is within a reference distance from the vehicle using the rear image; and providing information related to lane change to the adjacent lane if the other vehicle is within the reference distance.

In the present disclosure, the digital rear mirror device of vehicle may include a digital rear mirror module; and a processor, connected with the digital rear mirror module, and configured to obtain a rear image while the vehicle is traveling and display the rear image on the digital rear mirror module, wherein the processor may be configured to: recognize at least one other vehicle in an adjacent lane from the rear image; determine whether the other vehicle is within a reference distance from the vehicle using the rear image; and provide information related to lane change to the adjacent lane if the other vehicle is within the reference distance.

In the present disclosure, an image processing system of vehicle may include: a camera device configured to capture a rear image while the vehicle is traveling; and a digital rear mirror device having a digital rear mirror module and configured to display the rear image on the digital rear mirror module, wherein the digital rear mirror device may be configured to: recognize at least one other vehicle in an adjacent lane from the rear image; determine whether the other vehicle is within a reference distance from the vehicle using the rear image; and provide information related to lane change to the adjacent lane if the other vehicle is within the reference distance.

According to the present disclosure, the digital rear mirror device may provide rear view of the vehicle while determining whether a lane change of the vehicle is possible, thereby providing information related to change of vehicle. Specifically, the digital rear mirror device may analyze the rear image to determine whether the lane change of the vehicle is possible based on the distance between the vehicle and other vehicle in the adjacent lane, thereby providing information related to change of vehicle. In addition, the digital rear mirror device may provide the information related to change of vehicle in accordance with the approach speed of the other vehicle with respect to the vehicle. Thus, while driving the vehicle, the driver may decide whether to proceed with a lane change to an adjacent lane with reference to the distance and approach speed of other vehicles in the adjacent lane. That is, the digital rear mirror device helps the driver to decide whether to proceed with the lane change, so as to suppress or prevent an incorrect determination of the driver, and as a result, safety of the vehicle and the driver may be ensured.

### BRIEF DESCRIPTION OF THE DRAWINGS

FIG. 1 is a block diagram showing a configuration of an image processing system according to various embodiments.

FIG. 2 is a flow diagram showing signal flow in an image processing system according to various embodiments.

FIGS. 3A, 3B, and 3C are illustrative diagrams for illustrating operational features of a digital rear mirror device according to various embodiments.

FIG. 4 is a block diagram showing a configuration of a digital rear mirror device according to various embodiments.

FIG. 5 is a flowchart showing operating method for providing information related to lane change of digital rear mirror device according to various embodiments.

FIG. 6 is a flowchart showing one embodiment of operating method for setting the reference distance and the reference lines of digital rear mirror device according to various embodiments.

FIG. 7 is a flowchart showing another embodiment of operating method for setting the reference distance and the reference lines of digital rear mirror device according to various embodiments.

FIG. 8 is a flowchart showing still other embodiment of operating method for setting the reference distance and the reference lines of digital rear mirror device according to various embodiments.

FIG. 9 is a block diagram showing vehicle in which a digital rear mirror device is mounted according to various embodiments.

FIG. 10 is a block diagram showing control device of the vehicle of FIG. 9.

### DETAILED DESCRIPTION

Various embodiments of the present document are described below with reference to the accompanying drawings.

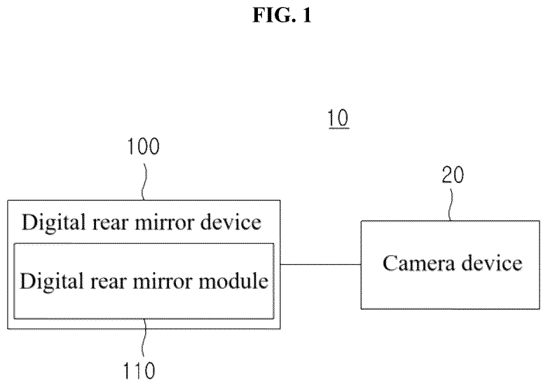

FIG. 1 is a block diagram showing a configuration of an image processing system 10 according to various embodiments.

Referring to FIG. 1, the image processing system 10 may include the camera device 20 and the digital rear mirror device 100. The image processing system 10 may be mounted on vehicle. In some embodiments, at least one other component may be added to the image processing system 10.

The camera device 20 may obtain image information about the surrounding environment of the vehicle. In some embodiments, the camera device 20 may store the image information in a memory in the camera device 20. The image information may include rear image of the vehicle. For this purpose, the camera device 20 may comprise a rear camera device mounted on the rear side of the vehicle, so as to face the rear of the vehicle. In some embodiments, the image information may further include at least one of a front image or a lateral image of the vehicle. In this case, the camera device 20 may further include at least one of a front camera device mounted on the front side of the vehicle, so as to face the front of the vehicle, or a lateral camera devices mounted on both sides of the vehicle, such as to face both sides of the vehicle.

The digital rear mirror device 100 may display image information obtained by the camera device 20. For this purpose, the digital rear mirror device 100 may be connected to the camera device 20. Specifically, the digital rear mirror device 100 may include the digital rear mirror module 110. The digital rear mirror module 110 may operate in at least one of mirror mode or display mode to provide the rear view of the vehicle. In mirror mode, the digital rear mirror module 110 may directly illuminate the rear view of the vehicle. In the display mode, the digital rear mirror module 110 may provide rear view of the vehicle by displaying rear image of the vehicle obtained by the camera device 20. For this purpose, the digital rear mirror module 110 may be arranged within the driver's field of front vision.

The camera device 20 and the digital rear mirror module 100 may be communicatively connected by wire or wirelessly. In some embodiments, the camera device 20 and the digital rear mirror device 100 may be connected through a communication cable. In an embodiment, the camera device 20 and the digital rear mirror device 100 may communicate in an analog manner. The analogue manner may include, for example, an analogue high definition (AHD). In other embodiments, the camera device 20 and the digital rear mirror device 100 may communicate in digital manner. For example, the digital manner may include a serial transmission method. In this case, the camera device 20 may include a serializer, and the digital rear mirror device 100 may include a deserializer. However, without being limited thereto, and the camera device 20 and the digital rear mirror device 100 may also be connected through internal network communication (e.g., CAN communication) of the vehicle. The camera device 20 and the digital rear mirror device 100 may include various communication chips.

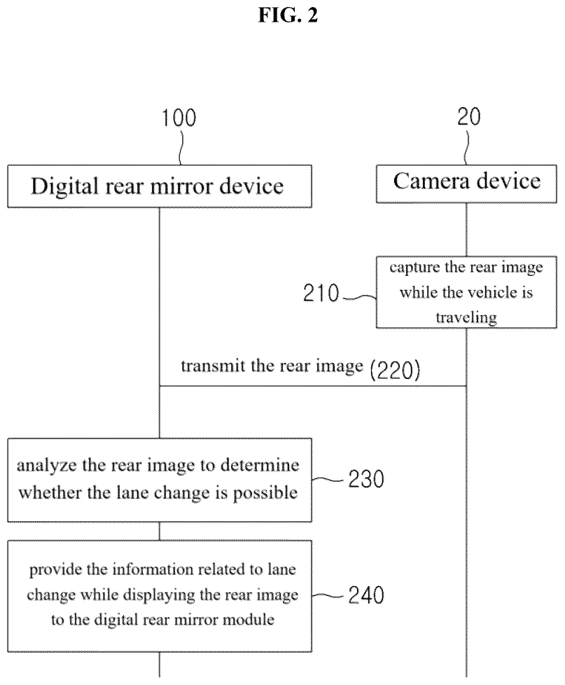

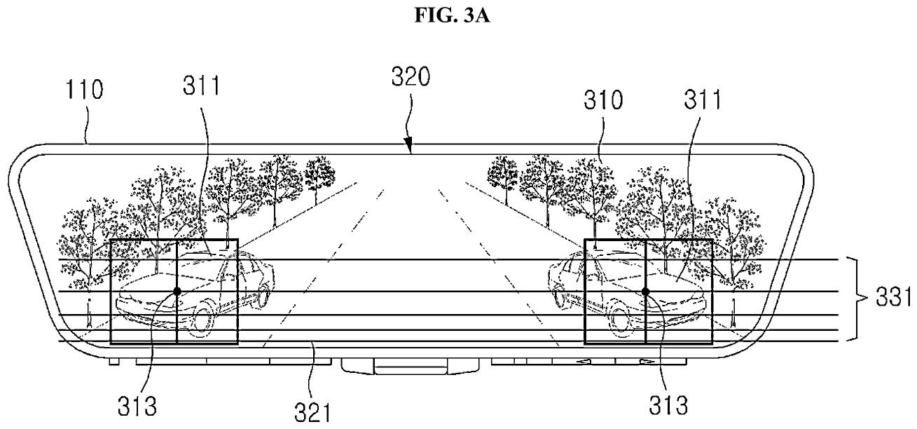

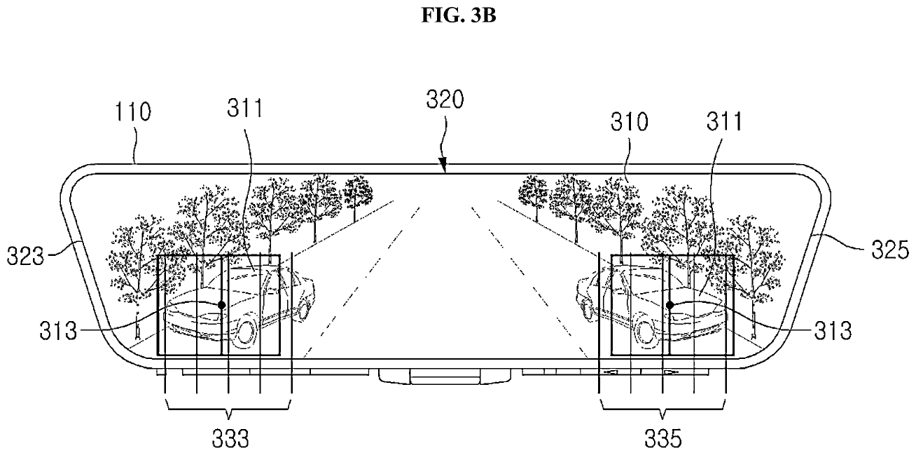

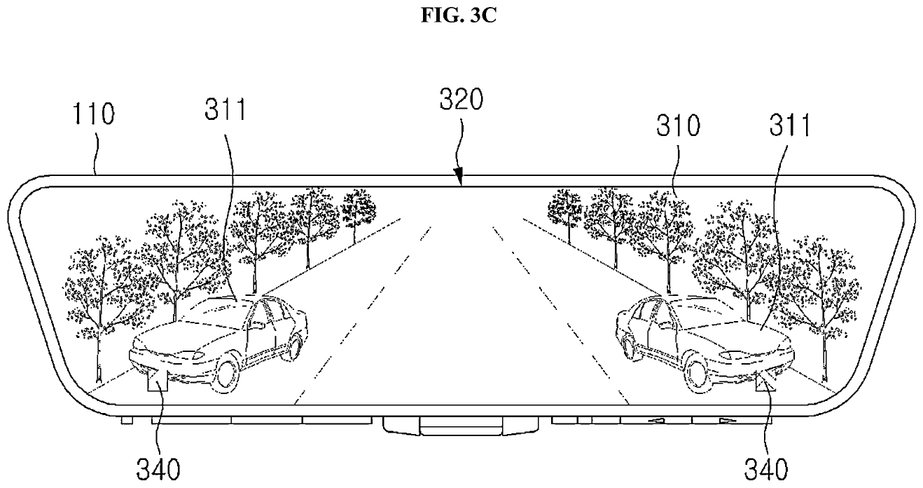

FIG. 2 is a flow diagram showing signal flow in an image processing system 10 according to various embodiments. FIGS. 3A, 3B, and 3C are illustrative diagrams for illustrating operational features of a digital rear mirror device 100 according to various embodiments.

Referring to FIG. 2, in step 210, the camera device 20 may capture the rear image while the vehicle is traveling. At this time, the camera device 20 may capture the rear image at any angle. The angle of the camera device 20 may be set by default or initially set by the user, and may be changed by the user. Here, the rear image may have a resolution and a size determined by the camera device 20. Then, in step 220, the camera device 20 may transmit the rear image to the digital rear mirror device 100. Thus, the digital rear mirror device 100 may receive the rear image from the camera device 20.

Next, in step 230, the digital rear mirror device 100 may analyze the rear image to determine whether the lane change is possible. Specifically, the digital rear mirror device 100 may recognize at least one other vehicle 311 in the adjacent lane from the rear image. The adjacent lane may include at least one of a left lane or a right lane of a lane in which the vehicle is traveling. The other vehicle 311 may represent a preceding vehicle in adjacent lane. Then, the digital rear mirror device 100 may determine whether there is other vehicle 311 within a reference distance from the vehicle using the rear image. In this case, the reference distance may be set by default or initially set by the user. Then, the reference distance may be changed by the user, or may be changed based on the traveling record of the vehicle collected for a predetermined period of time by the digital rear mirror device 100. In some embodiments, the digital rear mirror device 100 may also detect an approach speed of the other vehicle 311 to the vehicle.

According to various embodiments, the digital rear mirror device 100 may display rear image via the digital rear mirror module 110. At this time, as shown in FIGS. 3A and 3B, the digital rear mirror device 100 may display the field-of-view image 310 detected from the rear image through the digital rear mirror module 110. The field-of-view image 310 may be at least a portion of a back image. Here, the resolution of the field-of-view image 310 may be the same as or lower than the resolution of the rear image. Meanwhile, the size of the field-of-view image 310 may be the same as or smaller than the size of the rear image. The digital rear mirror module 110 may have a display screen 320 for displaying the field-of-view image 310. Here, the size of the field-of-view image 310 may be converted, e.g., enlarged, to the size of the digital rear mirror module 110.

According to various embodiments, the digital rear mirror device 100 may analyze the rear image while displaying the rear image through the digital rear mirror module 110. At this time, as shown in FIGS. 3A and 3B, the digital rear mirror device 100 may determine whether other vehicle 311 is within the reference distance from the vehicle, using the field-of-view image 310. To this end, the reference distance may be defined as reference lines 331, 333, 335 within the display screen 320. Here, the reference lines 331, 333, 335 are set for the one edge 321, 323, 325 of the display screen 320, and the reference distance may correspond to a distance between that edge 321, 323, 325 and the reference lines 331, 333, 335. That is, as the reference distance increases, the reference lines 331, 333, 335 may be set to be farther from that edge 321, 323, 325, and as the reference distance decreases, the reference lines 330, 333, 335 may be set to be closer to that edge 321, 323, 325. In addition, the reference lines 331, 333, 335 may be set within the display screen 320 according to the angle of the camera device 20 that captures the rear image. Therefore, in order to determine whether other vehicle 311 is within the reference distance from the vehicle, the digital rear mirror device 100 may detect recognition point 313 of the other vehicle 311 within the field-of-view image 310, and determine whether the recognition point 313 is between those edges 321, 323, 325 and the reference lines 331, 333, 335. Here, the recognition point 313 may be one of a center, a license plate, or a front bumper of the other vehicle 311.

According to an embodiment, as shown in FIG. 3A, the reference line 331 may be set with respect to the bottom edge 321 of the display screen 320. At this time, the reference line 331 may be a horizontal line. In this case, the digital rear mirror device 100 may determine whether there is a recognition point 313 of the other vehicle 311 in at least one of the left lane or the right lane between the bottom edge 321 and the reference line 331.

According to another embodiment, as shown in FIG. 3B, the reference lines 333, 335 may include at least one of a first reference line 333 set for the left edge 323 of the display screen 320 or a second reference line 335 set for the right edge 325 of the display screen 320. At this time, the first reference line 333 and the second reference line 335 may each be a vertical line. In this case, the digital rear mirror device 100 may determine whether there is a recognition point 313 of the other vehicle 311 in the left lane between the left edge 323 and the first reference line 333. Alternatively or additionally, the digital rear mirror device 100 may determine whether there is a recognition point 313 of the other vehicle 311 in the right lane between the right edge 325 and the second reference line 335.

According to some embodiments, the digital rear mirror device 100 may compare the previous rear image with the current rear image to detect the approach speed of the other vehicle 311 with respect to the vehicle. Specifically, the digital rear mirror device 100 may detect an approach speed of the recognition point 313 of the other vehicle 311.

Next, in step 240, the digital rear mirror device 100 may provide the information related to lane change while displaying the rear image through the digital rear mirror module 110. The information related to lane change may include at least one of information indicating whether a lane change is possible, a distance from other vehicle, or a speed of other vehicle. Here, the information related to lane change may be provided as at least one of visual information or auditory information. The visual information may include, for example, at least one of a text, an icon, an indicator, a symbol, or an image. The auditory information may include, for example, at least one of a voice or a notification sound.

According to an embodiment, the digital rear mirror device 100 may provide the information related to lane change as visual information. Specifically, the digital rear mirror device 100 may provide the information related to lane change as the visual information through the digital rear mirror module 110, or may provide the information related to lane change as visual information through a separate display module or alarm module. For example, as shown in FIG. 3C, the digital rear mirror device 100 may display at least one indicator 340 in the field-of-view image 310 through the digital rear mirror module 110. When a lane change to the adjacent lane is possible, that is, when there is no other vehicle 311 within a reference distance from the vehicle, the digital rear mirror device 100 may not display the indicator 340, or may display the indicator 340 in any color, such as, green, or any size. On the other hand, when the lane change to the adjacent lane is not possible, that is, when there is other vehicle 311 within the reference distance from the vehicle, the digital rear mirror device 100 may display the indicator 340 in any color, such as, yellow or red, or any size.

At this time, the digital rear mirror device 100 may display the visual information differently according to the approach speed of the other vehicle 311 with respect to the vehicle. As an example, when the approach speed of the other vehicle 311 is lower than a predetermined threshold, the digital rear mirror device 100 may display the indicator 340 in yellow, and when the approach speed of the other vehicle 311 is higher than that threshold, the digital rear mirror device 100 may displayed the indicator 340 in red. For another example, when the approach speed of the other vehicle 311 is lower than the predetermined threshold, the digital rear mirror device 100 may slowly flash the indicator 340, and when the approach speed the other vehicle 311 is higher than the predetermined threshold, the digital rear mirror device 100 may quickly flash the indicator 340. As another example, when the approach speed of the other vehicle 311 is lower than a predetermined threshold value, the digital rear mirror device 100 may display the indicator 340 in any size, and when the approach speed of the other vehicle 311 is higher than that threshold value, the digital rear mirror device 100 may display the indicators 340 in an enlarged size.

According to another embodiment, the digital rear mirror device 100 may provide the information related to lane change as auditory information. At this time, the digital rear mirror device 100 may display the auditory information differently according to the approach speed of the other vehicle 311 with respect to the vehicle. As an example, when the speed of the other vehicle 311 is lower than a predetermined threshold value, the digital rear mirror device 100 may output a notification sound at any volume, and when the approach speed of the other vehicle 311 is higher than that threshold value, the digital rear mirror device 100 may output the notification sound at a higher volume. For another example, when the speed of the other vehicle 311 is lower than a predetermined threshold, the digital rear mirror device 100 may repeatedly output the notification sound in any interval, and when the approach speed of the other vehicle 311 is higher than that threshold, the digital rear mirror device 100 may repeatedly output the notification sound in a shorter interval.

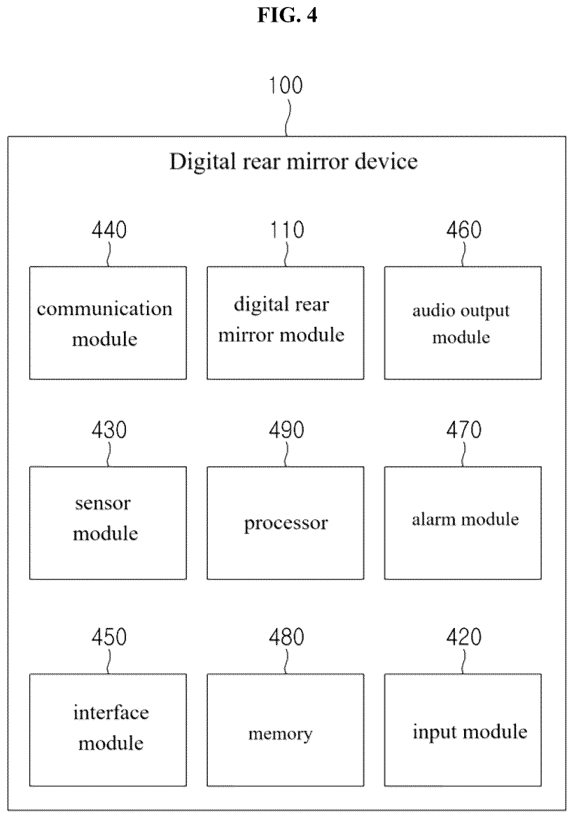

FIG. 4 is a block diagram showing a configuration of a digital rear mirror device 100 according to various embodiments.

Referring to FIG. 4, the digital rear mirror device 100 is mounted inside the vehicle together with the camera device 20, and may be communicatively connected to the camera device 20. Specifically, the digital rear mirror device 100 may include at least one of a digital rear mirror module 110, an input module 420, a sensor module 430, a communication module 440, an interface module 450, an audio output module 460, an alarm module 470, a memory 480, or a processor 490. In some embodiments, at least one of the components of the digital rear mirror device 100 may be omitted, and at least one other component (e.g., a display module) may be added. In some embodiments, at least two of the components of the digital rear mirror device 100 may be implemented in one integrated circuit. In an embodiment, the components of the digital rear mirror device 100 may be integrated and configured into a single unit. In this case, the components of the digital rear mirror device 100 may be housed within a single housing. In another embodiment, the components of the digital rear mirror device 100 may be distributed and configured into at least two units.

The digital rear mirror module 110 may be configured to provide a rear view of the vehicle. For example, the digital rear mirror module 110 may include at least one of a display, a holographic device, or a projector. In some embodiments, the digital rear mirror module 110 may be assembled with touch circuitry of the input module 420 and implemented as a touch screen. Then, the digital rear mirror module 110 may display the image information received from the processor 490. The digital rear mirror module 110 may have a display screen 320 in a predetermined resolution and size. The digital rear mirror module 110 may be accommodated in the housing such that the display screen 320 is exposed to the outside. In various embodiments, the digital rear mirror module 110 may operate in at least one of a mirror mode or a display mode. In mirror mode, the digital rear mirror module 110 may directly illuminate the rear view of the vehicle using the reflection of light. In the display mode, the digital rear mirror module 110 may display a rear image received from the processor 490 to provide a rear view of the vehicle. In various embodiments, the digital rear mirror module 110 may have an anti-glare function that is activated in accordance with an applied voltage. To this end, the display module 210 may be implemented by, for example, an electronic chromic (EC) method or a liquid crystal (LC) method.

The input module 420 may input a signal to be used for at least one component of the digital rear mirror device 100. The input module 420 may include, for example, at least one button (which may also be referred to as a key), a keyboard, a keypad, a mouse, a joystick, or a microphone. For example, the button may be arranged in at least one edge of the digital rear mirror module 110. Here, the button may include at least one of a physical button or a touch button. In some embodiments, the input module 420 may include touch circuitry that is assembled with the digital rear mirror module 110.

The sensor module 430 may generate an electrical signal or a data value corresponding to an internal operating state (e.g., power or temperature) of the digital rear mirror device 100 or an external environmental state. The sensor module 430 may include, for example, at least one of a motion sensor (which may also be referred to as a gesture sensor), a proximity sensor, a touch sensor, a radar sensor, a LIDAR sensor, a motion sensor, a gyro sensor, a barometric pressure sensor, a magnetic sensor, an acceleration sensor (e.g., a G sensor), a proximity sensors, an infrared (IR) sensor, a biometric sensor, a temperature sensor, a humidity sensor, or an illuminance sensor.

The communication module 440 may perform communication with an external device. The communication module 440 may establish a communication channel between the digital rear mirror device 100 and the external device, and perform communication with the external device through the communication channel. Here, the external device may include at least one of a satellite, a base station, a server, or an electronic device (e.g., used by a user). The communication module 440 may include at least one of a wired communication module or a wireless communication module. The wired communications module may be connected to the external device by wire to communicate via wire. The wireless communication module may include at least one of a short-range communication module or a long-range communication module. The short-range communication module may communicate with the external device in a short-range communication manner. For example, the short-range communication manner may include at least one of Bluetooth, Wi-Fi direct, or infrared data association (IrDA). The long-range communication module may communicate with the external device in a long-range communication manner. Here, the long-range communication module may communicate with the external device through a network. For example, the network may include at least one of a cellular network, the Internet, or a computer network such as a local area network (LAN) or a wide area network (WAN).

According to various embodiments, at least one of the input module 420, the sensor module 430, or the communication module 440 may generate a user input. In one embodiment, any sensor of the input module 420 or the sensor module 430 may generate the user input based on a signal directly input from a user. In another embodiment, the communication module 440 may generate the user input based on signal input from electronic device used by the user.

The interface module 450 may be provided for connection with the external device. Specifically, the interface module 450 may support a specified protocol that may be connected to the external device wired or wirelessly. Here, the external device may comprise at least one of the vehicle or the camera device 20. In an embodiment, when communicating with the camera device 20 in analog manner, the interface module 450 may receive image information from the camera device 20 and convert it from analog signal to digital data. In another embodiment, when communicating with the camera device 20 in digital manner, the interface module 450 may receive image information from the camera device 20 and convert it from serial data to parallel data. In such a case, the interface module 450 may be implemented as deserializer.

The audio output module 460 may output an audio signal generated from the digital rear mirror device 100. For example, the audio output module 460 may include at least one of a speaker or a receiver.

The notification module 470 may output a notification signal. The notification signal may include a light emitting signal. In this case, the notification module 470 may include a light emitting module, such as, a light emitting diode (LED) lamp. For example, the notification module 260 may be disposed at the lower part of the digital rear mirror device 110.

The memory 480 may store various data used by at least one component of the digital rear mirror device 100. For example, the memory 480 may include at least one of a volatile memory or a nonvolatile memory. The data may include at least one program and input data or output data associated therewith. The program may be stored in the memory 480 as software including at least one instruction, and may include, for example, at least one of an operating system, middleware, or an application. The memory 480 may include at least one of a first memory built in the digital rear mirror device 100 or a second memory detachable from the digital rear mirror device 100.

According to various embodiments, the memory 480 may store a database in which different reference distances and positions of different reference lines 331, 333, 335 within the display screen 320 are mapped, respectively. According to some embodiments, the memory 480 may store the database in which positions of different reference lines 331, 333, 335 within the display screen 320 are respectively mapped for combinations of different reference distances and different angles of the camera device 20 capturing the rear image. For example, the database may be as shown in Table 1 below.

TABLE 1

| Angle of camera | Reference | Position of reference line |
|---|---|---|
| device 20 | distance | (Distance from corresponding edge) |
| a | 3 m | 1.5 cm |
| | 5 m | 2.5 cm |
| | 7 m | 3.5 cm |
| | 10 m | 5.0 cm |
| | 15 m | 7.5 cm |
| — | — | — |
| — | — | — |
| — | — | — |

The processor 490 may control at least one component of the digital rear mirror device 100 by executing a program of the memory 480. Accordingly, the processor 490 may perform data processing or an operation. In this case, the processor 490 may execute instruction stored in the memory 480.

The processor 490 may obtain the rear image of the vehicle from the camera device 20 through the interface module 450. The processor 490 may display the rear image through the digital rear mirror module 110. At this time, the processor 490 may display the field-of-view image 310 detected from the rear image on the display screen 320 of the digital rear mirror module 110.

According to various embodiments, the processor 490 may determine whether the lane change is possible by analyzing the rear image while the vehicle is traveling. For this purpose, reference distance and reference lines 331, 333, 335 corresponding to one another may be set. Here, the reference lines 331, 333, 335 are set for the one edge 321, 323, 325 of the display screen 320, and the reference distance may correspond to a distance between that edge 321, 323, 325 and the reference lines 331, 333, 335. The processor 490 may associate the reference distance with the reference lines 331, 333, 335 based on the database of the memory 480. The reference distance may be set by default or initially set by the user. And, the reference distance may be changed by the user, or may be changed based on the traveling record of the vehicle collected for a predetermined period of time by the processor 490. For example, in response to the setting of one of the reference distance or reference lines 331, 333, 335, the processor 490 may set another one of the reference distance or the reference lines 331, 333, 335.

Specifically, the processor 490 may recognize at least one other vehicle 311 in the adjacent lane from the rear image. The adjacent lane may include at least one of a left lane or a right lane of the lane in which the vehicle is traveling. The other vehicle may represent a preceding vehicle in the adjacent lane. Then, the processor 490 may determine whether there is other vehicle 311 within the reference distance from the vehicle, using the rear image. More specifically, the processor 490 may detect a recognition point 313 of the other vehicle 311 within the field-of-view image 310 and determine whether the recognition point 313 is between corresponding edge 321, 323, 325 and the reference lines 331, 333, 335. Here, the recognition point 313 may be one of a center, a license plate, or a front bumper of the other vehicle 311. In some embodiments, the processor 490 may also detect an approach speed of the other vehicle 311 to the vehicle.

According to various embodiments, the digital rear mirror device 100 may provide information related to lane change while displaying the rear image through the digital rear mirror module 110. The information related to lane change may include at least one of information indicating whether the lane change is possible, a distance from another vehicle, or a speed of other vehicle. Here, the information related to lane change may be provided as at least one of visual information or auditory information. The visual information may include, for example, at least one of text, icon, indicator, symbol, or image. The auditory information may include, for example, at least one of voice or notification sound.

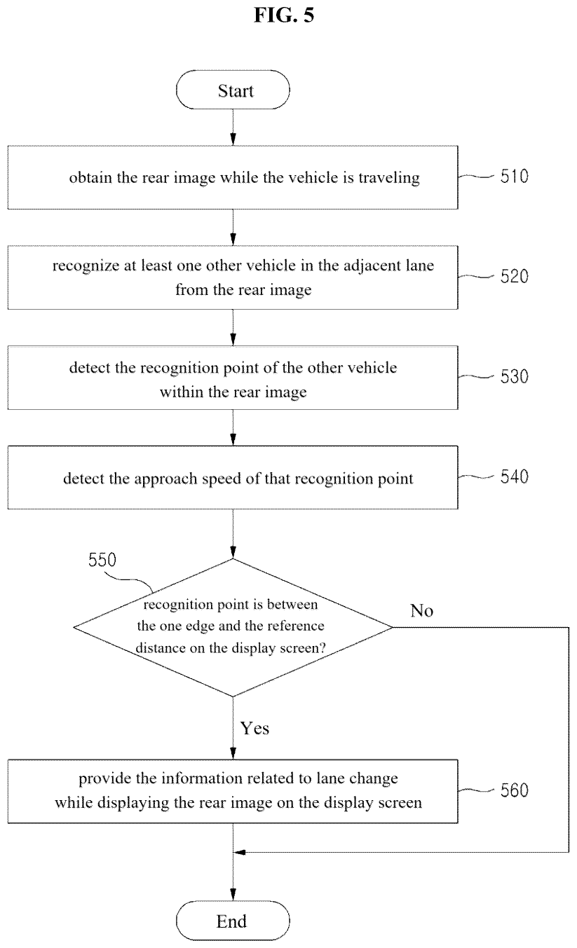

FIG. 5 is a flowchart showing operating method for providing information related to lane change of digital rear mirror device 100 according to various embodiments.

Referring to FIG. 5, in step 510, the digital rear mirror device 100 may obtain the rear image while the vehicle is traveling. For this purpose, the digital rear mirror device 100 may be communicatively connected to the camera device 20 in a wired or wireless manner. Specifically, the camera device 20 may capture the rear image while the vehicle is traveling. At this time, the camera device 20 may capture the rear image at any angle. The angle of the camera device 20 may be set by default or initially set by the user, and may be changed by the user. Here, the rear image may have resolution and size determined by the camera device 20. Therefore, by transmitting the rear image from the camera device 20 to the digital rear mirror device 100, the processor 490 may obtain the rear image from the camera device 20 through the interface module 450.

In this case, the processor 490 may display rear image via the digital rear mirror module 110. Specifically, as shown in FIGS. 3A and 3B, the processor 490 may display the field-of-view image 310 detected from the rear image through the digital rear mirror module 110. The field-of-view image 310 may be at least a portion of a back image. Here, the resolution of the field-of-view image 310 may be the same as or lower than the resolution of the rear image. Meanwhile, the size of the field-of-view image 310 may be the same as or smaller than the size of the rear image. The digital rear mirror module 110 may have a display screen 320 for displaying the field-of-view image 310. Here, the size of the field-of-view image 310 may be converted, e.g., enlarged, to the size of the digital rear mirror module 110. That is, the processor 490 may display the rear image on the display screen 320.

Next, in step 520, the digital rear mirror device 100 may recognize at least one other vehicle 311 in the adjacent lane from the rear image. Specifically, as shown in FIGS. 3A and 3B, the processor 490 may recognize other vehicle 311 from the field-of-view image 310. The adjacent lane may include at least one of a left lane or a right lane of the lane in which the vehicle is traveling. The other vehicle 311 may represent a preceding vehicle in the adjacent lane.

Next, in steps 530 to 550, the digital rear mirror device 100 may determine whether there is other vehicle 311 within the reference distance from the vehicle. At this time, the reference distance may be set in advance. The reference distance may be defined as reference lines 331, 333, 335 within the display screen 320. That is, reference distance and reference lines 331, 333, 335 corresponding to each other may be set. Here, the reference lines 331, 333, 335 are set for the one edge 321, 323, 325 of the display screen 320, and the reference distance may correspond to a distance between that edge 321, 323, 325 and the reference lines 331, 333, 335. That is, as the reference distance increases, the reference lines 331, 333, 335 may be set to be farther from that edge 321, 323, 325, and as the reference distance decreases, the reference lines 330, 333, 335 may be set to be closer to that edge 321, 323, 325. In addition, the reference lines 331, 333, 335 may be set within the display screen 320 according to the angle of the camera device 20 that captures the rear image.

At this time, the reference distance may be set by default or initially set by the user. And the reference distance may be changed by the user, or may be changed based on the traveling record of the vehicle collected by the processor 490 for a predetermined period of time. For example, the processor 490 may associate the reference distance with the reference lines 331, 333, 335 based on the database of the memory 480, so that, in response to the setting of one of the reference distance or the reference lines 331, 333, 335, the processor 490 may set another one of the reference distance or the reference lines 331, 333, 335. According to an embodiment, as shown in FIG. 3A, the reference line 331 may be set with respect to the bottom edge 321 of the display screen 320. At this time, the reference line 331 may be a horizontal line. According to another embodiment, as shown in FIG. 3B, the reference lines 333, 335 may include at least one of a first reference line 333 set for the left edge 323 of the display screen 320 or a second reference line 335 set for the right edge 325 of the display screen 320. At this time, the first reference line 333 and the second reference line 335 may each be a vertical line.

First, in step 530, the digital rear mirror device 100 may detect the recognition point 313 of the other vehicle 311 within the rear image. Specifically, as shown in FIGS. 3A and 3B, the processor 490 may detect the recognition point 313 of the other vehicle 311 within the field-of-view image 310. Here, the recognition point 313 may be one of a center, a license plate, or a front bumper of the other vehicle 311.

Then, in step 540, the digital rear mirror device 100 may detect the approach speed of that recognition point 313. Specifically, the processor 490 may detect the approach speed of that recognition point 313 by comparing the previous rear image with the current rear image. In this case, the processor 490 may detect the approach speed based on a change in a distance between one edge 321, 323, 325 of the display screen 320 and the recognition point 313.

Then, in step 550, the digital rear mirror device 100 may determine whether that recognition point 313 is between the one edge 321, 323, 325 and the reference lines 331, 333, 335 on the display screen 320. Specifically, the processor 490 may determine whether that recognition point 313 is between the corresponding edge 321, 323, 325 of the reference lines 331, 333, 335 and the reference lines 331, 333, 335. According to an embodiment, as shown in FIG. 3A, when the reference line 331 is set with respect to the bottom edge 321, the processor 490 may determine whether there is the recognition point 313 of the other vehicle 311 in at least one of the left lane and the right lane between the bottom edge 321 and the reference line 321. According to another embodiment, as shown in FIG. 3B, when the reference lines 333, 335 include at least one of the first reference line 333 set for the left edge 323 of the display screen 320 or the second reference line 335 set for the right edge 325 of the display screen 320, the processor 490 may determine whether there is the recognition point 313 of the other vehicle 311 in the left lane between the left edge 323 and the first reference line 333, and alternatively or additionally, the processor 490 may determine whether there are the recognition point 313 of other vehicles 311 in the right lane between the right edge 325 and the second reference line 335.

Next, in step 560, the digital rear mirror device 100 may provide the information related to lane change while displaying the rear image through the digital rear mirror module 110. The information related to lane change may include at least one of information indicating whether a lane change is possible, a distance from another vehicle, or a speed of another vehicle. Specifically, the processor 490 may provide the information related to lane change as at least one of visual information and auditory information while displaying the rear image on the display screen 320. The visual information may include, for example, at least one of a text, an icon, an indicator, a symbol, or an image. Here, the visual information may be output in the rear image through the digital rear mirror module 110, or may be output separately from the rear image. The auditory information may include, for example, at least one of a voice or a notification sound. In this case, the processor 490 may differently output the information related to lane change according to the approach speed of the other vehicle 311, that is, that recognition point 313 with respect to the vehicle.

According to an embodiment, the processor 490 may provide the information related to lane change as visual information. The processor 490 may provide the information related to lane change as the visual information through the digital rear mirror module 110, or may provide the information related to lane change as visual information through a separate display module or alarm module. For example, as shown in FIG. 3C, the processor 490 may display at least one indicator 340 in the field-of-view image 310 through the digital rear mirror module 110. When a lane change to the adjacent lane is possible, that is, when there is no other vehicle 311 within a reference distance from the vehicle, the digital rear mirror device 100 may not display the indicator 340, or may display the indicator 340 in any color, such as, green, or any size. On the other hand, when the lane change to the adjacent lane is not possible, that is, when there is other vehicle 311 within the reference distance from the vehicle, the processor 490 may display the indicator 340 in any color, such as, yellow or red, or any size.

At this time, the processor 490 may display the visual information differently according to the approach speed of the other vehicle 311 with respect to the vehicle. As an example, when the approach speed of the other vehicle 311 is lower than a predetermined threshold, the processor 490 may display the indicator 340 in yellow, and when the approach speed of the other vehicle 311 is higher than that threshold, the processor 490 may displayed the indicator 340 in red. For another example, when the approach speed of the other vehicle 311 is lower than the predetermined threshold, the processor 490 may slowly flash the indicator 340, and when the approach speed the other vehicle 311 is higher than the predetermined threshold, the processor 490 may quickly flash the indicator 340. As another example, when the approach speed of the other vehicle 311 is lower than a predetermined threshold value, the processor 490 may display the indicator 340 in any size, and when the approach speed of the other vehicle 311 is higher than that threshold value, the processor 490 may display the indicators 340 in an enlarged size.

According to another embodiment, the processor 490 may provide the information related to lane change as auditory information. Specifically, the processor 490 may provide information related to lane change as auditory information through the audio output module 460. At this time, the processor 490 may display the auditory information differently according to the approach speed of the other vehicle 311 with respect to the vehicle. As an example, when the speed of the other vehicle 311 is lower than a predetermined threshold value, the processor 490 may output a notification sound at any volume, and when the approach speed of the other vehicle 311 is higher than that threshold value, the processor 490 may output the notification sound at a higher volume. For another example, when the speed of the other vehicle 311 is lower than a predetermined threshold, the processor 490 may repeatedly output the notification sound in any interval, and when the approach speed of the other vehicle 311 is higher than that threshold, the processor 490 may repeatedly output the notification sound in a shorter interval.

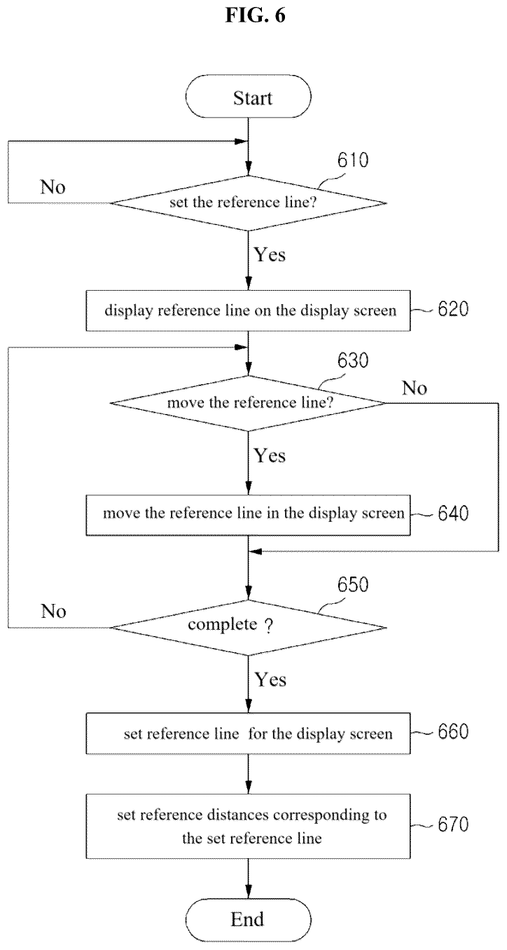

FIG. 6 is a flowchart showing one embodiment of operating method for setting the reference distance and reference lines 331, 333, 335 of digital rear mirror device 100 according to various embodiments.

Referring to FIG. 6, the digital rear mirror device 100 may initially set and/or change the reference distance and reference lines 331, 333, 335 by the user. Specifically, the processor 490 may set the reference distance as the reference lines 331, 333, 335 are set by the user.

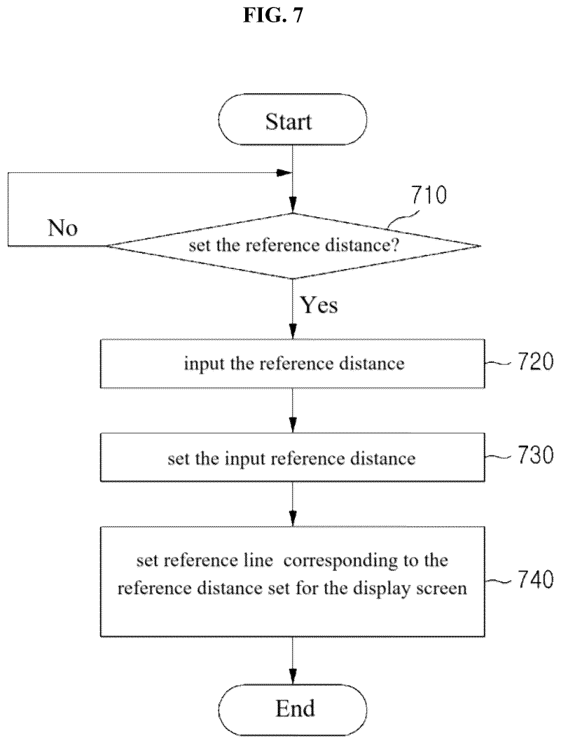

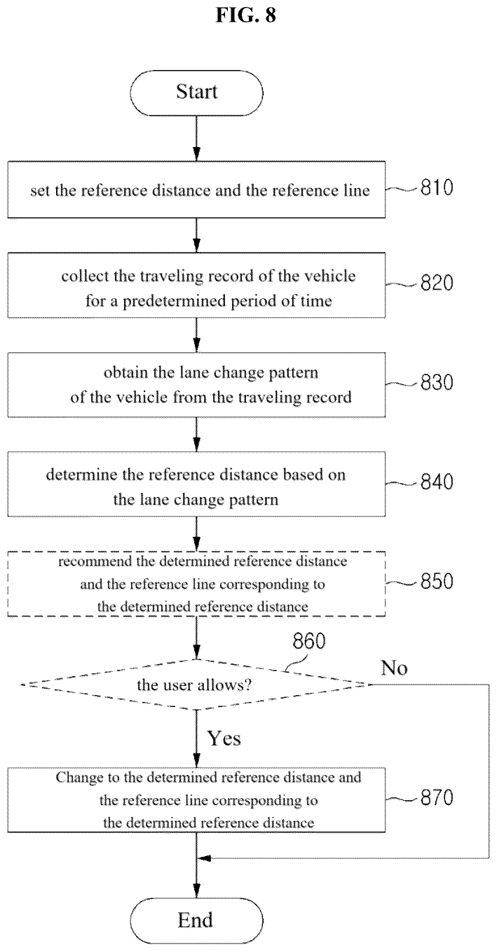

First, in step 610, the digital rear mirror device 100 may detect a user input for a request to set the reference lines 331, 333, 335. Specifically, when the user input is generated through at least one of the input module 420, the sensor module 430, or the communication module 440, the processor 490 may detect the user input. In response, in step 620, the digital rear mirror device 100 may display any reference lines 331, 333, 335 on the display screen 320 of the digital rear mirror module 110. Specifically, the processor 490 may display the reference lines 331, 333, 335 set by default or previously set according to the angle of the camera device 20 on the display screen 320. For example, the previously set reference lines 331, 333, 335 may be those previously set, as described with reference to FIG. 6, or as described below with reference to either FIG. 7 or 8. According to an embodiment, the reference line 331 may be a horizontal line corresponding to the bottom edge 321 of the display screen 320. According to another embodiment, the reference lines 333, 335 may be at least one vertical line corresponding to at least one of the left edge 323 or the right edge 325 of the display screen 320.

Next, in step 630, the digital rear mirror device 100 may detect a user input for moving the reference lines 331, 333, 335 within the display screen 320. Specifically, when the user input is generated through at least one of the input module 420, the sensor module 430, or the communication module 440, the processor 490 may detect it. In response, in step 640, the digital rear mirror device 100 may move the reference lines 331, 333, 335 within the display screen 320. Specifically, the processor 490 may move the reference lines 331, 333, 335 within the display screen 320 to correspond to the user input. According to an embodiment, when the reference line 331 is a horizontal line corresponding to the bottom edge 321 of the display screen 320, the processor 490 may move the reference line 332 farther or closer to the bottom edge 331. According to another embodiment, when the reference lines 333, 335 are at least one vertical line corresponding to at least one of the left edge 323 and the right edge 325 of the display screen 320, the processor 490 may move the reference lines 332, 335 farther or closer to each of the at least one of left edge 323 or right edge 325.

Next, in step 650, the digital rear mirror device 100 may sense a user input on completion of setting the reference lines 331, 333, 335. Specifically, when the user input is generated through at least one of the input module 420, the sensor module 430, or the communication module 440, the processor 490 may detect it. At this time, no user input for moving the reference lines 331, 333, 335 may be detected in step 630 and the user input for completion of setting the reference lines 331, 333, 355 may be detected, in step 650. In response, in step 660, the digital rear mirror device 100 may set reference lines 331, 333, 335 for the display screen 320. Specifically, the processor 490 may set final reference lines 331, 333, 335 on the display screen 320. That is, the final reference lines 331, 333, 335 may indicate the reference lines 331, 333, 335 in the display screen 320 when the user input is detected in step 650. When the user input is detected in step 630, the final reference lines 331, 333, 335 may represent the resultant reference lines 331, 333, 335 moved by the processor 490 in step 640. On the other hand, when no user input is detected in step 630, the final reference lines 331, 333, 335 may represent the reference lines 331, 333, 335 displayed by the processor 490 in step 620.

Next, in step 670, the digital rear mirror device 100 may set reference distance corresponding to the set reference lines 331, 333, 335. Specifically, the processor 490 may set reference distance corresponding to the set reference lines 331, 333, 335 based on the database of the memory 480. In this case, the processor 490 may set the reference distance in consideration of the set reference lines 331, 333, 335 and the angles of camera device 20.

FIG. 7 is a flowchart showing another embodiment of operating method for setting the reference distance and reference lines 331, 333, 335 of digital rear mirror device 100 according to various embodiments.

Referring to FIG. 7, the digital rear mirror device 100 may initially set and/or change the reference distance and reference lines 331, 333, 335 by the user. Specifically, the processor 490 may set the reference lines 331, 333, 335 as the reference distance is set by the user.

First, in step 710, the digital rear mirror device 100 may detect a user input for a request to set the reference distance. Specifically, when the user input is generated through at least one of the input module 420, the sensor module 430, or the communication module 440, the processor 490 may detect it. In this case, the processor 490 may output information about command for inputting the reference distance in response to the user input. For example, the processor 490 may display an input window for inputting the reference distance or display a plurality of candidate reference distances in a selectable form, through the digital rear mirror module 110 or a separate display module.

Next, in step 720, the digital rear mirror device 100 may input the reference distance. Specifically, when the user input for inputting the reference distance is generated through at least one of the input module 420, the sensor module 430, or the communication module 440, the processor 490 may input the reference distance in response to the user input. Then, in step 730, the digital rear mirror device 100 may set the input reference distance. That is, the processor 490 may set the input reference distance.

Next, in step 740, the digital rear mirror device 100 may set reference lines 331, 333, 335 corresponding to the reference distance set for the display screen 320 of the digital rear mirror module 110. Specifically, the processor 490 may set the reference lines 331, 333, 335 corresponding to the set reference distance based on the database of the memory 480. In this case, the processor 490 may set the reference lines 331, 333, 335 by considering both the set reference distance and the angle of the camera device 20.

FIG. 8 is a flowchart showing still other embodiment of operating method for setting the reference distance and the reference lines 331, 333, 335 of digital rear mirror device 100 according to various embodiments.

Referring to FIG. 8, the digital rear mirror device 100 may change the reference distance and the reference lines 331, 333, 335 based on the traveling record of the vehicle collected during a predetermined period of time. Specifically, the processor 490 may analyze the traveling record to change the previously set reference distance and the reference lines 331, 333, 335.

First, in step 810, the digital rear mirror device 100 may set the reference distance and the reference lines 331, 333, 335. Specifically, the processor 490 may set the reference distance and the reference lines 331, 333, 335 by default or by the user. In this case, the processor 490 may set the reference distance and the reference lines 331, 333, 335 according to the angle of the camera device 20. For example, the processor 490 may set the reference distance and the reference lines 331, 333, 335, as described with reference to FIG. 6 or 7.

Next, in step 820, the digital rear mirror device 100 may collect the traveling record of the vehicle for a predetermined period of time. Specifically, the processor 490 may obtain the traveling record from the vehicle. For example, the processor 490 may collect the traveling record in real time, or may obtain the traveling record after a predetermined period of time elapses.

Next, in step 830, the digital rear mirror device 100 may obtain the lane change pattern of the vehicle from the traveling record. Specifically, the processor 490 may analyze the traveling record to extract the lane change pattern. For example, the processor 490 may learn the traveling record through machine learning and extract the lane change pattern. In this case, if there are multiple drivers of the vehicle, the processor 490 may extract the lane change pattern for each driver.

Next, in step 840, the digital rear mirror device 100 may determine the reference distance based on the lane change pattern. Specifically, the processor 490 may determine the reference distance by analyzing the lane change pattern. For example, the processor 490 may determine the reference distance by learning the lane change pattern through machine learning. As an example, when the vehicle changes lanes, the processor 490 may check distances from the preceding vehicle in the adjacent lane and determine the reference distance as an average value of those distances. In this case, if there are multiple drivers of the vehicle e, the processor 490 may determine the reference distance for each driver.

In this case, the processor 490 may detect the reference lines 331, 333, 335 corresponding to the determined reference distance of the digital rear mirror module 110. Specifically, the processor 490 may detect the reference lines 331, 333, 335 corresponding to the determined reference distance, based on the database of the memory 480. In this case, the processor 490 may detect the reference lines 331, 333, 335 by considering both the determined reference distance and the angle of the camera device 20.

Additionally, in step 850, the digital rear mirror device 100 may recommend the determined reference distance and the reference lines 331, 333, 335 corresponding to the determined reference distance for the user. Specifically, the processor 490 may recommend the visually determined reference distance and the reference lines 331, 333, 335 corresponding to the determined reference distance through the digital rear mirror module 110 or a separate display module, or recommend the audibly determined reference distance and the reference lines 331, 333, 335 corresponding to the determined reference distance through the audio output module 460. Then, in step 860, the digital rear mirror device 100 may check whether the user allows the determined reference distance and the reference lines 331, 333, 335 corresponding to the determined reference distance. Specifically, when the user input is generated through at least one of the input module 420, the sensor module 430, or the communication module 440, the processor 490 may check whether the user is allowed based on this. At this time, if allowed by the user, the digital rear mirror device 100 may proceed to step 870.

Next, in step 870, the digital rear mirror device 100 may set the determined reference distance and the reference lines 331, 333, 335 corresponding to the determined reference distance. Specifically, the processor 490 may change the previously set reference distance and reference lines 331, 333, 335 to the determined reference distance and the reference lines 331, 333, 335 corresponding to the determined reference distance. In this case, the processor 490 may set the automatically determined reference distance and the reference lines 331, 333, 335 corresponding to the determined reference distance in step 870 without making a recommendation for the user. Alternatively, the processor 490 may set the reference distance determined in step 870 and the reference lines 331, 333, 335 corresponding to the determined reference distance, only when recommended for the user in step 850 and then allowed by the user in step 960.

According to the present disclosure, the digital rear mirror device 100 may provide rear view of the vehicle while determining whether a lane change of the vehicle is possible, thereby providing information related to change of vehicle. Specifically, the digital rear mirror device 100 may analyze the rear image to determine whether the lane change of the vehicle is possible based on the distance between the vehicle and other vehicle 311 in the adjacent lane, thereby providing information related to change of vehicle. In addition, the digital rear mirror device 100 may provide the information related to change of vehicle in accordance with the approach speed of the other vehicle 311 with respect to the vehicle. Thus, while driving the vehicle, the driver may decide whether to proceed with a lane change to an adjacent lane with reference to the distance and approach speed of other vehicles 311 in the adjacent lane. That is, the digital rear mirror device 100 helps the driver to decide whether to proceed with the lane change, so as to suppress or prevent an incorrect determination of the driver, and as a result, safety of the vehicle and the driver may be ensured.

In summary, the present disclosure provides digital rear mirror device 100 for providing information related to lane change of vehicle and operating method of the same.

In the present disclosure, a method of operating a digital rear mirror device 100 of a vehicle may include: obtaining a rear image while the vehicle is traveling (step 510); recognizing at least one other vehicle 311 in an adjacent lane from the rear image (step 520); determining whether the other vehicle 311 is within a reference distance from the vehicle using the rear image (steps 530 to 550); and providing information related to lane change to the adjacent lane if the other vehicle 311 is within the reference distance (step 560).

According to various embodiments, the providing information related to lane change (step 560) may include providing the information related to lane change while displaying the rear image on a display screen 320, and wherein the reference distance may correspond to a distance between a reference line 331, 333, 335 set for one edge 321, 323, 325 of the display screen 320 in the display screen 320.

According to various embodiments, the determining whether there is other vehicle 311 (steps 530 to 550) may include detecting a recognition point 513 of the other vehicle 311 (step 530), and determining whether the recognition point 513 is between the edge 321, 323, 325 and the reference lines 331, 333, 335 (step 550).

According to various embodiments, the adjacent lane may include at least one of a left lane or a right lane of a lane in which the vehicle is traveling.

According to an embodiment, the reference line 331 is set with respect to the bottom edge 321 of the display screen 320, and the determining whether there is the recognition point 513 (step 550) may include determining whether there is the recognition point 513 of the other vehicle 311 in at least one of the left lane or the right lane between the bottom edge 321 and the reference line 331.

According to another embodiment, the reference lines 333, 335 may include at least one of a first reference line 333 set for a left edge 323 of the display screen 320 and a second reference line 335 set for the right edge 325 of the display screen 320, and the determining whether there is the recognition point 513 (step 550) may include at least one of: determining whether there is the recognition point 513 of the other vehicle 311 in the left lane between the left edge 323 and the first reference line 333; or determining whether there is the recognition point 513 of the other vehicle 311 in the right lane between the right edge 325 and the second reference line 335.

According to various embodiments, the reference lines 331, 333, 335 may be set within the display screen 320 according to an angle of a camera device 20 that captures the rear image together with the reference distance.

According to various embodiments, the determining whether there is other vehicle 311 (steps 530 to 550) may further include comparing the rear image with the previous rear image to detect an approach speed of the recognition point 513 of the other vehicle 311 (step 540), and the providing information related to lane change (step 560) may include outputting the information related to lane change according to the approach speed.

According to various embodiments, the information related to lane change may include at least one of visual information or auditory information.

According to various embodiments, the other vehicle 311 may be a preceding vehicle in an adjacent lane.

According to various embodiments, the recognition point 513 may be one of a center, a license plate, or a front bumper of the other vehicle 311.

According to various embodiments, the reference distance may be initially set or changeable by the user.

According to various embodiments, the reference distance may be calculated from the reference lines 331, 333, 335 within the display screen 320 in response to the user setting the reference lines 331, 333, 335 within the display screen 320 while viewing the display screen 320; or the reference distance may be input by the user to cause the reference lines 331, 333, 335 to be set corresponding to the reference distance.

According to various embodiments, the reference distance may be changeable based on a lane change pattern obtained from a traveling record of the vehicle collected for a predetermined period of time, and as the reference distance changes, the reference lines 331, 333, 335 may change.

In the present disclosure, the digital rear mirror device 100 of vehicle may include a digital rear mirror module 110; and a processor 490, connected with the digital rear mirror module 110, and configured to obtain a rear image while the vehicle is traveling and display the rear image on the digital rear mirror module 110, wherein the processor 490 may be configured to: recognize at least one other vehicle 311 in an adjacent lane from the rear image; determine whether the other vehicle 311 is within a reference distance from the vehicle using the rear image; and provide information related to lane change to the adjacent lane if the other vehicle 311 is within the reference distance.

According to various embodiments, the digital rear mirror module 110 may have a display screen 320 for displaying the rear image; and the reference distance may correspond to the distance between reference lines 331, 333, 335 set with respect to one edge 321, 323, 325 of the display screen 320 within the display screen 320.

According to various embodiments, the processor 490 may be configured to detect a recognition point 513 of the other vehicle 311, and determine whether the recognition point 513 is between the edge 321, 323, 325 and the reference lines 331, 333, 335.

According to various embodiments, the adjacent lane may include at least one of a left lane or a right lane of a lane in which the vehicle is traveling.

According to an embodiment, the reference line 331 is set with respect to a bottom edge 321 of the display screen 320, and the processor 490 may be configured to determine whether there is the recognition point 513 of the other vehicle 311 in at least one of the left lane or the right lane between the bottom edge 321 and the reference line 331.

According to another embodiment, the reference lines 333, 335 may include at least one of a first reference line 333 set for the left edge 323 of the display screen 320 and a second reference line 335 set for the right edge 325 of the display screen 320, and the processor 490 may be configured to perform at least one of the following: determining whether there is the recognition point 513 of the other vehicle 311 in the left lane between the left edge 323 and the first reference line 333; or determining whether there is the recognition point 513 of the other vehicle 311 in the right lane between the right edge 325 and the second reference line 335.

According to various embodiments, the reference lines 331, 333, 335 may be set in the display screen 320 according to the angle of the camera device 20 that captures the rear image together with the reference distance.

According to various embodiments, it may further include a memory storing a database in which positions of different reference lines 331, 333, 335 within the display screen 320 are respectively mapped to combinations of different reference distances and different angles of the camera device 20 that captures the rear image, wherein the processor 490 may be configured to associate, based on the database, the reference distance with the reference lines 331, 333, 335.

According to various embodiments, the processor 490 may be configured to compare the previous rear image with the rear image, detect an approach speed of the recognition point 513 of the other vehicle 311, and output information related to lane change according to the approach speed.

According to various embodiments, the information related to lane change may include at least one of visual information or auditory information.

According to various embodiments, the other vehicle 311 may be the preceding vehicle in the adjacent lane.

According to various embodiments, the recognition point 513 may be one of the center, a license plate, or a front bumper of the other vehicle 311.

According to various embodiments, the reference distance may be initially set or changeable by the user.

According to various embodiments, the reference distance may be calculated from the reference lines 331, 333, 335 within the display screen 320 in response to the user setting the reference lines 331, 333, 335 within the display screen 320 while viewing the display screen 320; or the reference distance may be input by the user to cause the reference lines 331, 333, 335 to be set corresponding to the reference distance.

According to various embodiments, the reference distance may be changeable based on a lane change pattern obtained from a traveling record of the vehicle collected for a predetermined period of time, and as the reference distance changes, the reference lines 331, 333, 335 may change.

In the present disclosure, an image processing system 10 of vehicle may include: a camera device 20 configured to capture a rear image while the vehicle is traveling; and a digital rear mirror device 100 having a digital rear mirror module 110 and configured to display the rear image on the digital rear mirror module 110, wherein the digital rear mirror device 100 may be configured to: recognize at least one other vehicle 311 in an adjacent lane from the rear image; determine whether the other vehicle 311 is within a reference distance from the vehicle using the rear image; and provide information related to lane change to the adjacent lane if the other vehicle 311 is within the reference distance.

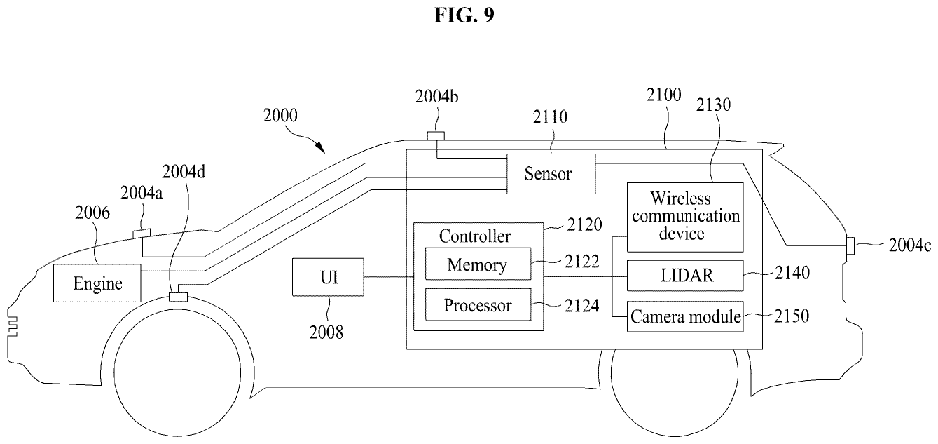

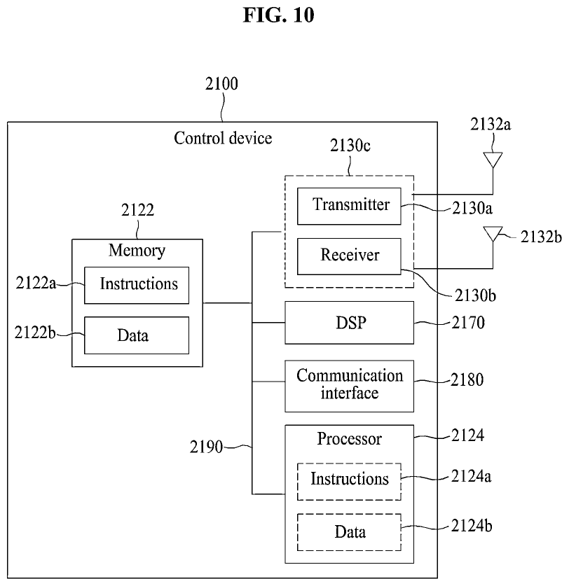

FIG. 9 is a block diagram showing vehicle 2000 in which the image processing system 10 is mounted according to various embodiments. FIG. 10 is a block diagram showing the control device 2100 of the vehicle in FIG. 9.

Referring to FIGS. 9 and 10, the image processing system 10 according to various embodiments may be mounted on the vehicle 2000, and the vehicle 2000 may include a control device 2100. In this case, the vehicle 2000 may be an autonomous vehicle. In some embodiments, at least one component of the image processing system 10 may be integrated into at least one component in the control device 2100.

The control device 2100 may include the controller 2120 including the memory 2122 and the processor 2124, the sensor 2110, a wireless communication device 2130, the LIDAR 2140, and the camera module 2150.

The controller 2120 may be configured at the time of manufacture by the manufacturer of the vehicle or further configured for performing the function of autonomous driving after manufacture. Alternatively, an upgrade of the controller 2120 configured during manufacture may include configuration for continued performance of additional functions.

The controller 2120 may transmit the control signal to the sensor 2110, the engine 2006, the user interface (UI) 2008, the wireless communication device 2130, the LIDAR 2140, and the camera module 2150 included in other configurations in the vehicle. The control signal may also be transmitted to the acceleration device, the braking system, the steering device, or the navigation device, which are not shown but are associated with the traveling of the vehicle.

The controller 2120 may control the engine 2006, for example, detect a speed limit of a road on which the vehicle 2000 is traveling and control the engine 2006 so that the traveling speed does not exceed the speed limit, or control the engine 2006 to accelerate the traveling speed of the vehicle 2000 within a range not exceeding the speed limit. In addition, when the sensing modules 2004a, 2004b, 2004c, 2004d detect an environment outside the vehicle and transmit it to the sensor 2110, the controller 2120 may receive it and generate a signal for controlling the engine 2006 or the steering device (not shown) to control traveling of the vehicle.

The controller 2120 may control the engine 2006 or braking system to decelerate the traveling vehicle if there is other vehicle or obstruction in front of the vehicle, and may control the trajectory, travel path, and steering angle in addition to the speed. Alternatively, the controller 2120 may control the traveling of the vehicle by generating a necessary control signal according to other recognition information of the other external environment, such as a traveling lane and a traveling signal of the vehicle.

The controller 2120, in addition to the generating of its own control signal, is also capable of controlling the traveling of the vehicle by performing communication with a surrounding vehicle or a central server and transmitting instructions to control peripheral devices based on the received information.

In addition, when the position of the camera module 2150 is changed or the angle of view is changed, it may be difficult to accurately recognize the vehicle or the lane, and thus the controller 2120 may generate a control signal for controlling to perform calibration of the camera module 2150 to prevent this. Accordingly, the controller 2120 may continuously maintain the normal mounting position, direction, angle of view, and the like of the camera module 2150 even when the mounting position of the camera module 2150 is changed due to vibration, impact, or the like generated according to the movement of the autonomous vehicle 2000 by generating the calibration control signal from the camera module 2150. The controller 2120 may generate the control signal to perform calibration of the camera module 2150 when the pre-stored initial mounting position, direction, and angle of view information of the camera modules 2150 and the initial mounting position, the direction, and the angle of view information measured while the autonomous vehicle 2000 is traveling are different from each other by a threshold value or more.

The controller 2120 may include the memory 2122 and the processor 2124. The processor 2124 may execute software stored in the memory 2122 according to the control signal of the controller 2120. Specifically, controller 2120 stores data and instructions in memory 2122 for detecting the field-of-view image from the rear image of vehicle 2000, which instructions may be executed by processor 2124 to implement one or more methods disclosed herein.

In this case, the memory 2122 may be stored in a recording medium executable by the nonvolatile processor 2124. Memory 2122 may store software and data through appropriate internal and external devices. The memory 2122 may be comprised of a random access memory (RAM), a read only memory (ROM), a hard disk, and a memory 2122 device connected to a dongle.

The memory 2122 may store at least an operating system (OS), a user application, and executable instructions. The memory 2122 may also store application data and arrangement data structures.

The processor 2124 may be a microprocessor or suitable electronic processor such as a controller, microcontroller, or state machine.

The processor 2124 may be implemented as a combination of computing devices, which may be digital signal processors, microprocessors, or any suitable combination thereof.

In addition, the control device 2100 may monitor characteristics of the inside and outside of the vehicle 2000 and sense a state with at least one sensor 2110.

The sensor 2110 may be comprised of at least one sensing module 2004, and the sensing module 2004 may be implemented at a specific location of the vehicle 2000 according to a detecting purpose. It may be located at a lower part, a rear end, a front end, an upper end, or a side end of the vehicle 2000, and may also be located in an internal component or a tire of the vehicle.

As a result, the sensing module 2004 may detect information related to traveling, such as the engine 2006, tires, the steering angle, the speed, and the weight of the vehicle, as internal information of the vehicle. In addition, the at least one or more sensing module 2004 may be comprised of the acceleration sensor 2110, a gyroscope, the image sensor 2110, the RADAR, the ultrasonic sensor, the LiDAR sensor, and the like, and may detect motion information of the vehicle 2000.

The sensing module 2004 is capable of receiving, as external information, specific data on external environment states, such as state information of a road on which the vehicle 2000 is located, information on surrounding vehicle, and weather, and detecting the corresponding parameters of the vehicle. The detected information may be stored in memory 2122 on temporary or long-term purposes.

The sensor 2110 may integrate and collect information of the sensing modules 2004 for collecting information generated inside and outside the vehicle 2000.

The control device 2100 may further include the wireless communication device 2130.

The wireless communication device 2130 is configured to implement wireless communication between the vehicles 2000. For example, the vehicle 2000 may communicate with a user's mobile phone, another wireless communication device 2130, other vehicle, the central device (traffic control device), the server, or the like. The wireless communication device 2130 may transmit and receive wireless signals according to the connection wireless protocol. The wireless communication protocol may be Wi-Fi, Bluetooth, Long-Term Evolution (LTE), Code Division Multiple Access (CDMA), Wideband Code Division Multiple Access (WCDMA), Global Systems for Mobile Communications (GSM), and the communication protocol is not limited thereto.

In addition, the vehicle 2000 is capable of implementing vehicle-to-vehicle communication through the wireless communication device 2130. That is, the wireless communication device 2130 may perform communication with another vehicle and other vehicles on the road through vehicle-to-vehicle communication (V2V). The vehicle 2000 may transmit and receive information such as a traveling warning, traffic information, and environmental information through vehicle-to-vehicle communication, and is also capable of requesting information from other vehicles or receiving such requests. For example, the wireless communication device 2130 may perform V2V communication with a dedicated short-range communication (DSRC) device or a Celluar-V2V (C-V2V) device. In addition to vehicle-to-vehicle communication, vehicle to everything communication (V2X) between the vehicle and another object (e.g., an electronic device carried by a pedestrian) may also be implemented through the wireless communication device 2130.

In addition, the control device 2100 may include the LIDAR device 2140. The LIDAR device 2140 may detect an object around the vehicle 2000 during operation by using data sensed by the LIDAR sensor. The LIDAR device 2140 may transmit the detected information to the controller 2120, and the controller 2120 may operate the vehicle 2000 according to the detected information. For example, when the detection information indicates that there is a vehicle traveling at a low speed ahead, the controller 2120 may instruct the vehicle to reduce the speed through the engine 2006. Alternatively, it may instruct the vehicle to reduce its entry speed based on the curvature of a curve the vehicle is entering.

The control device 2100 may further include the camera module 2150. The controller 2120 may extract object information from the external image captured by the camera module 2150 and cause the controller 2120 to process the corresponding information.

In addition, the control device 2100 may further comprise imaging devices for recognizing the external environment. In addition to LIDAR 2140, RADAR, GPS devices, Odometry, and other computer vision devices may be used, and these devices may be selected or operated simultaneously as needed to enable more precise detecting.

The vehicle 2000 may further include the user interface 2008 for user input to the control device 2100 described above. User interface 2008 may allow the user to input information with appropriate interaction. For example, it may be implemented through touchscreen, keypad, operation button, or the like. The user interface 2008 may transmit the input or instruction to the controller 2120, and the controller 2120 may perform the control operation of the vehicle in response to the input or instruction.

The user interface 2008 may also allow the device external to the vehicle 2000 to communicate with the vehicle 2000 via the wireless communication device 2130. For example, user interface 2008 may be interoperable with mobile phone, tablet, or other computer device.

Further, although the vehicle 2000 is described as including the engine 2006, it is possible to include other types of propulsion systems. For example, the vehicle may be powered by electrical energy and may be powered via hydrogen energy or a hybrid system combining these. Accordingly, the controller 2120 may include a propulsion mechanism according to the propulsion system of the vehicle 2000, and may provide a control signal corresponding thereto to the components of each propulsion mechanism.

Hereinafter, the detailed configuration of the control device 2100 of the vehicle 2000 will be described in more detail with reference to FIG. 10.

The control device 2100 includes the processor 2124. The processor 2124 may be a general purpose single- or multi-chip microprocessor, dedicated microprocessor, microcontroller, programmable gate array, or the like. The processor 2124 may also be referred to as central processing unit (CPU). Note that the processor 2124 is also capable of being used as a combination of multiple processors.

The control device 2100 also comprises a memory 2122. The memory 2122 may be any electronic component capable of storing electronic information. Memory 2122 may also include a combination of memories 2122 in addition to a single memory.

According to various embodiments, data and instructions 2122a of vehicle 2000 may be stored in memory 2122. When the processor 2124 executes the instructions 2122a, all or part of instructions 2122a and data 2122b necessary for execution of the instructions may also be loaded 2124a, 2124b onto the processor 2124.

The control apparatus 2100 may include the transmitter 2130a, the receiver 2130b, or the transceiver 2130c for allowing transmission and reception of signals. The one or more antennas 2132a, 2132b may be electrically connected to the transmitter 2130a, the receiver 2130b, or each transceiver 2130c and may also include additional antennas.

The control device 2100 may also include the digital signal processor (DSP) 2170. The DSP 2170 may allow the vehicle to process digital signals quickly.

The control apparatus 2100 may include the communication interface 2180. The communication interface 2180 may also include one or more ports and/or communication modules for connecting other devices with the control devices 2100. The communication interface 2180 may allow the user to interact with the control device 2100.

Various configurations of the control device 2100 may be connected together by one or more buses 2190, and the buses 2190 may include a power bus, a control signal bus, a status signal bus, a data bus, and the like. Under the control of the processor 2124, the components may be made to transmit information to each other through the bus 2190 and perform the desired functions.

The devices described above may be implemented as hardware components, software components, and/or combinations of hardware components and software components. For example, the devices and components described in the embodiments may be implemented using one or more general-purpose or special-purpose computers, such as processors, controllers, arithmetic logic unit (ALU), digital signal processor, microcomputer, field programmable gate array (FPGA), programmable logic unit (PLU), microprocessor, or any other device capable of executing and responding to instructions. The processing device may execute an operating system (OS) and one or more software applications executed on the operating system. Further, the processing device may access, store, manipulate, process, and generate data in response to execution of the software. For ease of understanding, it may be described that one processing device is used, but a person skilled in the art may know that the processing device may include a plurality of processing elements and/or a plurality of types of processing elements. For example, the processing device may include a plurality of processors or one processor and one controller. Other processing configurations, such as parallel processors, are also possible.

The software may include computer program, code, instruction, or combinations of one or more of these, and may configure the processing device to operate as desired or may instruct the processing device independently or collectively. Software and/or data may be embodied in any type of machine, component, physical device, computer storage medium, or device for interpretation by, or provision of instructions or data to, a processing device. The software may be distributed on a networked computer system, stored or executed in a distributed manner. The software and data may be stored in one or more computer readable recording media.

Methods in accordance with various embodiments may be embodied in the form of program instructions and recorded on a computer-readable medium, which may be executed by a variety of computer means. At this time, the medium may continue to store the computer-executable program, or temporarily store it for execution or download. In addition, the medium may be various recording means or storage means in the form of a single piece or a combination of several pieces of hardware, and is not limited to a medium directly connected to a certain computer system, and may be distributed on a network. Examples of media may include magnetic media such as hard disks, floppy disks, and magnetic tape, optical recording media such as CD-ROM and DVD, magneto-optical media such as floptical disk, and those configured to store program instructions, including ROMs, RAMs, flash memories, and the like. Examples of the other medium include a recording medium and a storage medium managed by an app store that distributes an application, a site that supplies or distributes various other software, a server, and the like.

It is to be understood that the various embodiments of this document, and the terminology used therein, are not intended to limit the technology described herein to particular embodiments, but are to encompass various modifications, equivalents, and/or alternatives of those embodiments. In connection with the description of the figures, like reference numerals may be used for like components. The singular forms “a,” “an,” and “the” may include the plural forms as well, unless the context clearly indicates otherwise. In this document, expressions such as “A or B”, “at least one of A and/or B”, “A, B, or C” or “at least one A, B, and/or C” may include all possible combinations of the listed items together. Expressions such as “the first”, “the second”, “first”, or “second” may modify corresponding components regardless of order or importance, and are only used to distinguish one component from another component and do not limit that components. When an element (e.g., the first element) is referred to as being “(functionally or communicatively) connected” or “connected” to other element (e.g., the second element), the element may be directly connected to the other element or may be connected through other element (e.g., the third element).

The term “module” used in this document includes a unit configured by hardware, software, or firmware, and may be used interchangeably with a term such as logic, a logic block, a component, or a circuit. A module may be an integrally constructed component or a minimum unit or part thereof that performs one or more functions. For example, the module may be configured as an application-specific integrated circuit (ASIC).

According to various embodiments, each component (e.g., module or program) of the described components may include one or more entities. According to various embodiments, one or more components or steps of that components described above may be omitted, or one or more other components or steps may be added. Alternatively or additionally, multiple components (e.g., modules or programs) may be integrated into a single component. In such a case, the integrated component may perform one or more functions of each component of the plurality of components the same as or similar to those performed by that component of the plurality before integration. According to various embodiments, the steps performed by a module, program or other component may be executed sequentially, in parallel, iteratively, or heuristically, one or more of the steps may be executed in a different order, omitted, or one or more other steps may be added.

What is claimed is:

1. A method of operating digital rear mirror device of vehicle, the method comprising:
obtaining a rear image while the vehicle is traveling;
recognizing at least one other vehicle in an adjacent lane from the rear image;
determining whether the other vehicle is within a reference distance from the vehicle using the rear image; and
providing information related to lane change to the adjacent lane if the other vehicle is within the reference distance.

2. The method of operating digital rear mirror device of claim 1, wherein:
the providing information related to lane change comprises:
providing the information related to lane change while displaying the rear image on a display screen, and
wherein the reference distance corresponds to a distance between a reference line set for one edge of the display screen in the display screen.

3. The method of operating digital rear mirror device of claim 2, comprising:
the determining whether there is another vehicle comprises:
detecting a recognition point of the other vehicle; and
determining whether the recognition point is between the edge and the reference line.

4. The method of operating digital rear mirror device of claim 2, wherein:
the adjacent lane comprises at least one of a left lane or a right lane of a lane in which the vehicle is traveling,
the reference line is set with respect to a bottom edge of the display screen, and
the determining whether there is the recognition point comprises:
determining whether there is the recognition point of the other vehicle in at least one of the left lane or the right lane between the bottom edge and the reference line.

5. The method of operating digital rear mirror device of claim 2, wherein:
the adjacent lane comprises at least one of a left lane or a right lane of a lane in which the vehicle is traveling,
the reference line comprises at least one of a first reference line set for the left edge of the display screen and a second reference line set for the right edge of the display screen, and
the determining whether there is the recognition point comprises at least one of:
determining whether there is the recognition point of the other vehicle in the left lane between the left edge and the first reference line; or
determining whether there is the recognition point of the other vehicle in the right lane between the right edge and the second reference line.

6. The method of operating digital rear mirror device of claim 2, wherein:
the reference line is set within the display screen according to an angle of a camera device that captures the rear image together with the reference distance.

7. The method of operating digital rear mirror device of claim 3, wherein:
the determining whether there is another vehicle further comprises:
comparing the rear image with the previous rear image to detect an approach speed of the recognition point of the other vehicle, and
wherein the providing information related to lane change comprises:
outputting the information related to lane change according to the approach speed.

8. The method of operating digital rear mirror device of claim 3, wherein:
the recognition point is one of a center, a license plate, or a front bumper of the other vehicle.

9. The method of operating digital rear mirror device of claim 2, wherein:
the reference distance is initially set or changeable by the user; and
the reference distance is calculated from the reference line within the display screen in response to the user setting the reference line within the display screen while viewing the display screen; or
the reference distance is input by the user to cause the reference line to be set corresponding to the reference distance.

10. The method of operating digital rear mirror device of claim 2, wherein:
the reference distance is changeable based on a lane change pattern obtained from a traveling record of the vehicle collected for a predetermined period of time, and as the reference distance changes, the reference lines changes.

11. A digital rear mirror device for a vehicle, comprising:
a digital rear mirror module; and
a processor, connected with the digital rear mirror module, and configured to obtain a rear image while the vehicle is traveling and display the rear image on the digital rear mirror module,
wherein the processor is configured to:
recognize at least one other vehicle in an adjacent lane from the rear image;
determine whether the other vehicle is within a reference distance from the vehicle using the rear image; and
provide information related to lane change to the adjacent lane if the other vehicle is within the reference distance.

12. The digital rear mirror device of claim 11, wherein:
the digital rear mirror module has a display screen for displaying the rear image; and
the reference distance corresponds to the distance between reference lines set with respect to one edge of the display screen within the display screen.

13. The digital rear mirror device of claim 12, wherein:
the processor is configured to:
detect a recognition point of the other vehicle; and
determine whether the recognition point is between the edge and the reference line.

14. The digital rear mirror device of claim 12, wherein:
the adjacent lane comprises at least one of a left lane or a right lane of a lane in which the vehicle is traveling, and
the reference line is set with respect to a bottom edge of the display screen, and
the processor is configured to:
determine whether there is the recognition point of the other vehicle in at least one of the left lane or the right lane between the bottom edge and the reference line.

15. The digital rear mirror device of claim 12, wherein:
the adjacent lane comprises at least one of a left lane or a right lane of a lane in which the vehicle is traveling,
the reference line comprises at least one of a first reference line set for the left edge of the display screen and a second reference line set for the right edge of the display screen, and
the processor is configured to perform at least one of the following:
determining whether there is the recognition point of the other vehicle in the left lane between the left edge and the first reference line; or
determining whether there is the recognition point of the other vehicle in the right lane between the right edge and the second reference line.

16. The digital rear mirror device of claim 12, wherein:
the reference line is set within the display screen according to an angle of a camera device that captures the rear image together with the reference distance.

17. The digital rear mirror device of claim 12, further comprising:
a memory storing a database in which positions of different reference lines within the display screen are respectively mapped to combinations of different reference distances and different angles of the camera device that captures the rear image;
wherein the processor is configured to:
associate, based on the database, the reference distance with the reference lines.

18. The digital rear mirror device of claim 13, wherein:
the processor is configured to:
compare the rear image with the previous rear image to detect an approach speed of the recognition point of the other vehicle; and
output the information related to lane change according to the approach speed.

19. The digital rear mirror device of claim 12, wherein:
the reference distance is initially set or changeable by the user; and
the reference distance is calculated from a position of the reference line within the display screen in response to the user moving the reference line within the display screen while viewing the display screen; or
the reference distance is input by the user to cause the reference line to be set corresponding to the reference distance.

20. The digital rear mirror device of claim 12, wherein:
the reference distance is changeable based on a lane change pattern obtained from a traveling record of the vehicle collected for a predetermined period of time, and as the reference distance changes, the reference lines changes.
